(19) United States
(12) Patent Application Publication
(10) Pub. No.: US 2016/0179438 A1
(43) Pub. Date: Jun. 23, 2016

(54) METHOD FOR TRACKING IMAGE DATA PRINTED ON A PIECE OF MEDIA

(71) Applicant: OCE-TECHNOLOGIES B.V., Venlo (NL)

(72) Inventors: Anne A. WIND, Venlo (NL); Wilhelmus J.E.G. VERHOFSTAD, Venlo (NL)

(73) Assignee: OCE-TECHNOLOGIES B.V., Venlo (NL)

(21) Appl. No.: 15/058,666

(22) Filed: Mar. 2, 2016

Related U.S. Application Data
(63) Continuation of application No. PCT/EP2014/069621, filed on Sep. 15, 2014.

(30) Foreign Application Priority Data
Sep. 17, 2013 (EP) 13184773.3

(51) Int. Cl. G06F 3/12

(52) U.S. Cl. CPC G06F 3/1203; G06F 3/1263; G06F 3/1285

(57) ABSTRACT

The invention relates to a method for printing print jobs on media by means of a printer system, the printer system comprising a control unit and a digital storage, the media comprising an identification unit for identifying locations of image data and other related information in the digital storage, the identification unit wireless connected to the control unit, the method comprises the steps of receiving a print job by the control unit, printing image data of the print job on the media, storing the image data of the print job on a location in the digital storage, and storing a link to the location on the identification unit after printing the image data on the media. The invention also relates to a printing system suitable for applying the invented method.

### FIELD OF THE INVENTION

The invention relates to a method for printing print jobs on a piece of media by means of a printer system, the printer system comprising a control unit and a digital storage, the method comprises the steps of, for each print job to be printed on the piece of media, receiving the print job by the control unit, printing image data of the print job on the piece of media, and storing the image data of the print job on a location in the digital storage.

### BACKGROUND OF THE INVENTION

Printing systems may have tracking software for tracking the print job during the digital printing steps. However, bottlenecks for a print job typically may occur in the analogue domain after printing like the finishing domain. Without information from the analogue domain tracking software has little added value in these environments. Especially when a plurality of print jobs is printed on one piece of piece media it is difficult to deduce which print jobs have been printed on the piece of media. The piece of media may be for example a roll of media used in a roll-to-roll printing system or a large rigid board used in a flatbed printing system.

It is an objective of the invention to facilitate an easier way of tracking image data printed on a piece of media.

### SUMMARY OF THE INVENTION

According to the present invention this object is achieved by a method according to the preamble, wherein the printer system further comprises an identification unit for identifying locations of image data in the digital storage, the identification unit wireless connected to the control unit and attached to the piece of media, the method comprises the further step of, for each print job to be printed on the piece of media, storing a link to the location on the identification unit after printing the image data on the piece of media.

As soon as image data of a print job is printed on the piece of media, a link to the location of the image data in the digital storage unit is stored in the identification unit attached to the piece of media. The image data may be stored on the location when the print job is received by the control unit. The image data may also be stored on the location during or after printing the print job on the piece of media. By doing so, the identification unit always comprises links to locations on the storage unit on which locations image data of all jobs printed on the same piece of media are stored. The operator is able to read out the links from the identification unit via a hand held device. The hand held device is wireless connected to the control unit and the operator is able to get available information such as an overview of all printed image data on the piece of media, positioning of the image on the media, grouping of images that will be finished with the same finishing equipment etcetera, in order to organise the work of the operator in an optimal way. This is advantageous when the operator is near the piece of media and not near the control unit. The operator does not need to walk to a user interface of the control unit of the printing system for getting an overview via the user interface of the control unit.

The links from the identification unit may also be read out by a dedicated device provided with dedicated software application programs for further processing of the read out information.

According to an embodiment of the method, the method comprises, for each print job to be printed on the piece of media, the further step of storing job specifications of the printed job on the location. An operator who is viewing the image data which are printed on the piece of media, may check if the printed image data is according to the job specifications, if printed image data is correctly grouped and if time requirements are met.

According to an embodiment of the method the identification unit is detachable from the piece of media. In this way the identification unit may be re-used for other pieces of media to be used for printing. The links stored on the identification unit may be erased after the identification unit is detached from the piece of media. The identification unit may then be attached to a new piece of media on which not yet any image data has been printed.

According to an embodiment of the method the printer system is a roll-to-roll printer system and the piece of media is a roll of media. The method is particularly advantageous when the media is wrapped upon a roll. When the media on the roll is completely printed with image data of print jobs, only the last printed image data may be visible at a first sight on the roll. Image data of previous jobs is usually hidden in the internal media part on the roll. The stored links on the identification unit on the roll are useful to get an overview of all the print jobs and corresponding image data printed on the roll with respect to positioning of the images on the roll, grouping of images and timing requirements to be met.

According to a further embodiment of the method a plurality of print jobs is printed on the roll in a scheduled sequence order and image data of each of the plurality of print jobs are stored on the location in a same sequence order as the scheduled sequence order. By doing the sequence order of the image data on the roll becomes known to the operator and can be useful when further processing the roll, for example in a cutting device.

According to an embodiment of the method the printer system is a flat bed printer and the piece of media is suitable for printing a plurality of print jobs on the piece of media.

The stored links on the identification unit on the piece of media are useful to get an overview of all the print jobs and corresponding image data printed on the piece of media.

According to a further embodiment the plurality of print jobs is printed on the piece of media and image data of the plurality of print jobs is grouped into dedicated images wherein the grouping is based on one of optimal use of the piece of media, similar images together, images from a single job together and purposive grouping of images due to a next production step. For example, image data of each of the plurality of print jobs is grouped into at least one image representing the piece of media on which the plurality of images has been printed, and storing the at least one image on the location. The dedicated images together contain all image data printed on corresponding places on the piece of media. The operator can check if the image data on the piece of media correspond to the number of print jobs which are scheduled to be printed on the piece of media.

The invention also relates to a recording medium comprising computer executable program code configured to instruct a computer to perform a method according to any of the previous embodiments of the method according to the invention.

The invention also relates to a printer system for printing a print job on a piece of media, the printer system comprising a storage unit for storing digital data and a control unit for controlling the printing of the print job, the control unit wireless connected to an identification unit which is attached to the piece of media, wherein the control unit is configured to store image data of the print job on a location on the storage unit and the control unit is configured to store a link to the location on the identification unit after printing of the print job on the piece of media. The printer system may be a roll-to-roll printer or a flat bed printer or any other printer suitable for processing a plurality of print jobs on one piece of media.

It may be clear for the skilled person that the previous embodiments of the printer system may be combined in one way or another resulting in embodiments which also fall under the scope of the invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the scope of the invention will become apparent to those skilled in the art from this detailed description.

### BRIEF DESCRIPTION OF THE DRAWINGS

Hereinafter the present invention is further elucidated with references to the appended drawings showing non-limiting embodiments and wherein:

FIG. 1 schematically shows a first print system in which the invented method is applicable;

FIG. 2 schematically shows a second print system in which the invented method is applicable; and

FIG. 3 is a flow diagram of the method according to the invention.

### DETAILED DESCRIPTION OF EMBODIMENTS

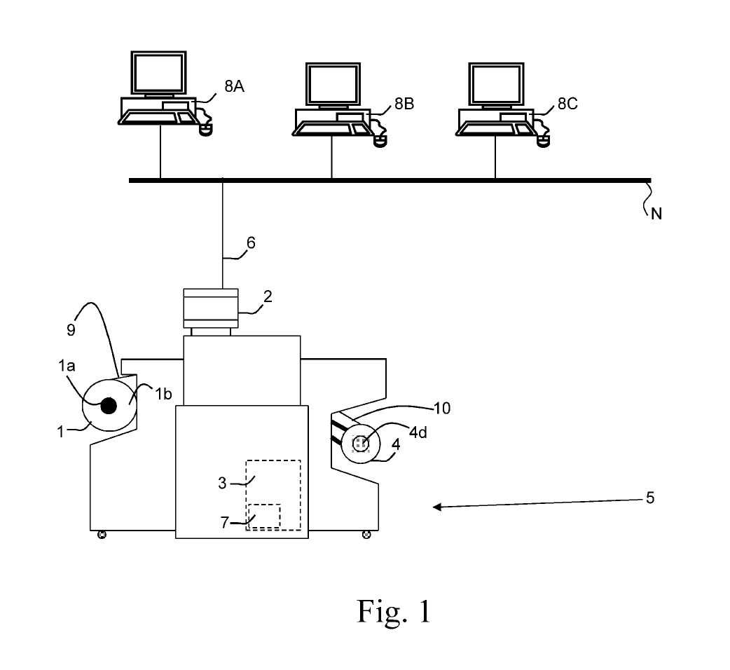

FIG. 1 shows a first printing system comprising workstations 8A-8C connected to a network N. A reproduction apparatus 5 is available for a user working with one of the workstations 8A-8C and intending to send a print job comprising a set of documents from one of the workstations 8A-8C to the reproduction apparatus 5. The reproduction apparatus 5 is connected to the network N via wired or wireless connecting means 6 and suited for receiving print jobs from the workstations 8A-8C. The network N may be wireless. The reproduction apparatus 5 comprises a local user interface unit 2 suitable for displaying print jobs, selecting a print job and editing settings of a print job. A control unit 3 is suited to store a queue of print jobs, to check whether or not the queue is empty and to submit a document from a queued print job to the print engine of the reproduction apparatus 5 in order to be printed. Image data of a print job are stored in the storing means 7 contained in the control unit 3 at least for the time period that the document is printed by the print engine and finished by finishing means. Image data may also be stored in memory (not shown) of at least one of the workstations 8A-8C.

The shown reproduction apparatus 5 works up a first roll 1 of wrapped media having a length which is defined as a largest dimension of the media when completely unrolled. Media material may be paper, textile, metal plates, printed circuit plates, solar cell plates, overhead sheet material, plastic or any other kind of suitable receiving material or substrate. The first roll 1 has been put in a holder. An end grain of the first roll 1 comprises a part 1a of the core of the roll 1 and a side part 1b of the media of the roll 1. In FIG. 1 the core of the first roll 1 and the side part of the media on the first roll 1 are visible. Media 9 given out of the first roll 1 is going to be printed upon with image data by the reproduction apparatus 5. The media 9 is entering the reproduction apparatus 5 on the left side and leaving as printed media 10 provided with image data on the right side of the reproduction apparatus 5. The printed media 10 is wrapped up upon a second roll 4—similar to the first roll 1. The second roll 4 is loaded in another holder. The second roll 4 is provided with an identification unit 4d attached to the core of the second roll 4. The identification unit 4d may be a RFID tag, an identification unit enabling WIFI identification, an ID card or any other hardware unit suitable for storing digital links. The identification unit 4d comprises a sender/receiver unit for wireless sending data to the network N and wireless receiving data from the network N. According to the invention a digital link to a location in memory 7 in the control unit 3 or to a location in memory of one of the workstations 8A-8C is stored on the identification unit 4d as soon as image data located at the location in memory has been printed by the reproduction apparatus 5. The media on the second roll 4 is suitable for comprising printed image data of a plurality of print jobs. In case that more than one print job has been printed upon the second roll 4 a digital link will be stored on the identification unit 4d for each print job.

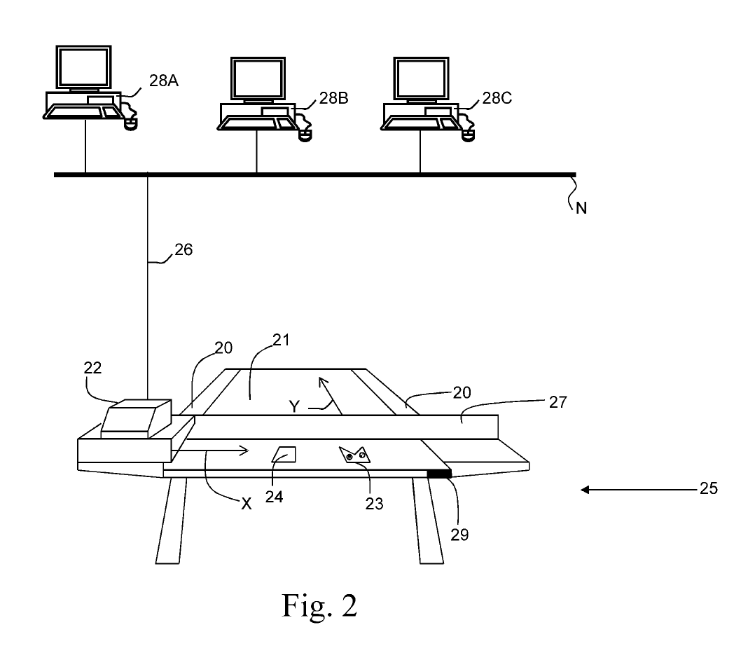

FIG. 2 shows a second print system 25 comprising a number of workstations 28B, 28C, which may be personal computers or other devices for preparing image data for prints to be printed. These workstations have access to a network N via a wired or wireless connection 26 for transferring the image data to a print controller 28A that is configured to receive print jobs for prints and derive pass images. The print controller 28A may be part of the print system 25 that further comprises a print head 22 for applying colorants, for example cyan (C), magenta (M), yellow (Y), black (K) and white (W) colorant, or varnish to a rigid board 21 placed on a flat bed surface 20 in order to print image data of a plurality of print jobs upon the rigid board 21. The flat bed surface 20 is the surface of the flat bed which is at least partially printable by the print head 22. It is noted that the rigid board may be of an arbitrary shape and at an arbitrary position on the flat bed surface 20. The rigid board 21 may be so small that it is completely placed on the flat bed surface 1 or the rigid board 21 may larger than the flat bed surface, in which case image data which is going to cover the whole rigid board must be printed in a number of steps such that between the steps the rigid board is shifted in the right position. A first print job comprising image data 23 and a second print job comprising image data 24 have already been printed on the rigid board, while image data of other print jobs may be printed on the rigid board when the print head 22 moves in a first direction Y. The print head 22 reciprocally scans the flat bed surface 20 in a second direction X along a gantry 27 perpendicular to the first direction Y of the gantry 27 over the flat bed surface 20. During printing of image data 23, 24 the rigid board 21 is not moved on the flat bed surface 20. A print head which is as wide as the flat bed surface may also be envisaged within the scope of the invention. Such a print head may be moveable in at least one direction over the flat bed surface 20.

The rigid board 21 is provided with an identification unit 29 attached to a side of the rigid board 21. The identification unit 29 may be a RFID tag, an identification unit enabling WI Fl identification, an ID card or any other hardware unit suitable for storing digital links. The identification unit 29 comprises a sender/receiver unit for wireless sending data to the network N and wireless receiving data from the network N. According to the invention a digital link to a location in memory in the printer controller 28A or to a location in memory of one of the workstations 28B, 28C is stored on the identification unit 29 as soon as image data located at the location in memory has been printed upon the rigid board 21 by the print system 25. The rigid board 21 is suitable for comprising printed image data of a plurality of print jobs. In case that more than one print job has been printed upon the rigid board 21 a digital link will be stored on the identification unit 29 for each print job.

The printer system 25 comprises a user interface which, in this embodiment, is integrated in printer controller 28A for selecting a print job and optionally adapting a print job parameter, such as a print mode which controls the number of passes over a given swath on the media. In another embodiment a user interface is provided as a network site that is accessible with a browser on a client computer.

After sending a print job comprising image data from a workstation to the printer controller 28A, the print job will be made visible on the user interface. It may be scheduled for further processing after selection from a list of print jobs or, alternatively, if the print job is on top of the list of print jobs.

In the embodiment of the second print system 25 a rigid board is used as media to be printed upon. Other media may be envisioned such as piece of media suitable for printing a plurality of print jobs on the piece of media., like plain paper sheets or rigid boards of several thicknesses and a size larger than a regular A4-A3 format or larger than a regular B4-B3 format, for example A2, A1, A0, etc.

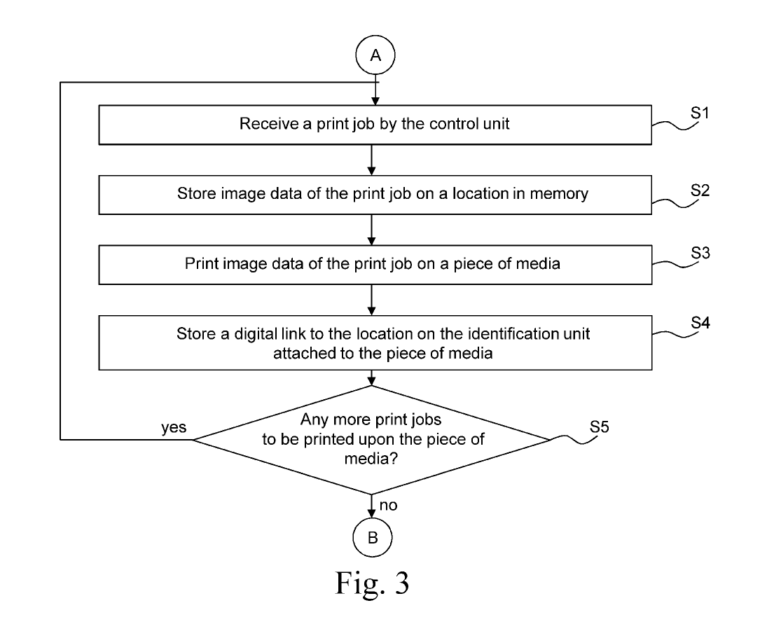

FIG. 3 is a flow diagram of the method according to the invention. From a starting point A a first step S1 is reached. According to the first step S1 a print job is received by the control unit. The print job comprises print job specifications and image data. According to a second step S2 the image data of the print job is stored on a location in memory. The memory may be part of the control unit or may be part of a workstation connected to the print system. Besides image data also positions of the image on the piece of media, left/right orientation of the image on the piece of media, rotation degree of the image on the piece of media may be stored as well as any other information that an operator needs to know or is helpful for the work of the operator.

According to a third step S3 the image data is printed on the piece of media. An identification unit is attached to the piece of media before printing the print job. According to a fourth step S4 a digital link to the location is stored on the identification unit by means of the receiving means of the identification unit.

In a fifth step S5 it is checked if there are any more print jobs to be printed upon the piece of media. If not so, the method ends in end point B.

If there is still a print job to be printed upon the piece of media, the method returns to the first step S1.

When the method ends in end point B, the identification unit comprises at least one link to a location in memory. The identification unit may be read out by a mobile device via near-field communication, blue tooth or via any other wireless network to check which image data are printed on the piece of media.

In a further embodiment of the method a plurality of print jobs is printed on the piece of media.

If the piece of media is a roll of media the print jobs are printed in a scheduled sequence order. The locations of the image data of the respective print jobs may be organised in the same sequence order in memory.

If the piece of media is a large piece of media, like an A0, A1, A2 format size, a further step may be added to the method. The further step comprises grouping of the image data of the plurality of jobs into one image representing the large piece of media when the plurality of print jobs have been printed upon the large piece of media. The plurality of links may even be combined into one link leading to the one image.

Grouping of links may also be applied within the framework of optimal usage of the piece of media, similar images together, images from one job together, purposive grouping of images due to a next production step, for example images which lead to a same next finishing step etc.

The above disclosure is intended as merely exemplary, and not to limit the scope of the invention, which is to be determined by reference to the following claims.

1. A method for printing print jobs on a piece of media by means of a printer system, the printer system comprising a control unit, a digital storage and an identification unit for identifying locations of image data in the digital storage, the identification unit wirelessly connected to the control unit and attached to the piece of media, the method comprises the steps of, for each print job to be printed on the piece of media:
a) receiving the print job by the control unit;
b) printing image data of the print job on the piece of media;
c) storing the image data of the print job on a location in the digital storage; and
d) storing a link to the location on the identification unit after printing the image data on the piece of media.

2. The method according to claim 1, wherein the method comprises the further step of, for each print job to be printed on the piece of media:
e) storing job specifications of the print job on the location.

3. The method according to claim 1, wherein the identification unit is detachable from the piece of media.

4. The method according to claim 1, wherein the printer system is a roll-to-roll printer system and the piece of media is a roll of media.

5. The method according to claim 4, further comprising the steps of:
printing a plurality of print jobs on the roll in a scheduled sequence order; and
storing image data of each of the plurality of print jobs on the location in a same sequence order as the scheduled sequence order.

6. The method according to claim 1, wherein the printer system is a flat bed printer and the piece of media is a piece of media suitable for printing a plurality of print jobs on the piece of media.

7. The method according to claim 6, further comprising the steps of:
printing the plurality of print jobs on the piece of media;
grouping image data of each of the plurality of print jobs into one image representing the piece of media on which the plurality of images is printed; and
storing the one image on the location.

8. The method according to claim 6, further comprising the steps of:
printing the plurality of print jobs on the piece of media; and
grouping image data of the plurality of print jobs into dedicated images,
wherein the grouping is based on one of optimal use of the piece of media, similar images together, images from a single job together and purposive grouping of images due to a next production step.

9. A non-transitory computer readable medium comprising computer executable program code configured to instruct a computer to perform the method according to claim 1.

10. A printer system for printing a print job on a piece of media, the printer system comprising:
A digital storage configured to store digital data; and
a control unit configured to control the printing of the print job,
wherein the control unit is wirelessly connected to an identification unit attached to the piece of media, wherein the control unit is configured to store image data of the print job on a location on the digital storage and the control unit is configured to store a link to the location on the identification unit after printing of the print job on the piece of media.

11. A non-transitory computer readable medium comprising computer executable program code configured to instruct a computer to perform the method according to claim 2.

12. A non-transitory computer readable medium comprising computer executable program code configured to instruct a computer to perform the method according to claim 3.

13. A non-transitory computer readable medium comprising computer executable program code configured to instruct a computer to perform the method according to claim 4.

14. A non-transitory computer readable medium comprising computer executable program code configured to instruct a computer to perform the method according to claim 5.

15. A non-transitory computer readable medium comprising computer executable program code configured to instruct a computer to perform the method according to claim 6.

16. A non-transitory computer readable medium comprising computer executable program code configured to instruct a computer to perform the method according to claim 7.

17. A non-transitory computer readable medium comprising computer executable program code configured to instruct a computer to perform the method according to claim 8.
